(19) United States
(12) Patent Application Publication
(10) Pub. No.: US 2007/0043856 A1
(43) Pub. Date: Feb. 22, 2007

(54) Methods and systems for low-latency event pipelining

(75) Inventors: Dirk A. Morris, San Carlos, CA (US); John D. Irwin, San Francisco, CA (US); Robert B. Scott, Pasadena, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Metavize, Inc., San Mateo, CA (US)

(21) Appl. No.: 11/349,590

(22) Filed: Feb. 7, 2006

Related U.S. Application Data
(60) Provisional application No. 60/651,096, filed on Feb. 7, 2005.

(51) Int. Cl. G06F 15/173

(52) U.S. Cl. 709/224

(57) ABSTRACT

Methods and systems for low-latency event pipelining. According to an embodiment, the present invention provides a method for reducing a latency associated with the stream of information passes through the virtual pipeline. The method is performed in a network system, wherein a stream of information passes through a virtual pipeline of a plurality of modules. The method includes a step for receiving the stream of information from a first network portion at a first time to define an initiation time. The method includes a step for processing the stream of information into a plurality of events. The plurality of events includes a first event and a second event. The method includes a step for processing the first event in a first format at a first module of the plurality of modules to determine if the first event is passed to a second module, redirected to another process, or changed to the first event in a second format, or not passed.

### CROSS-REFERENCES TO RELATED APPLICATIONS

This application claims priority to Provisional Application No. 60/651,096 filed Feb. 7, 2005, commonly assigned and hereby incorporated by reference for all purposes.

### BACKGROUND OF THE INVENTION

The present invention relates to network systems. In particular, the present invention provides a method and system for reducing latency time of data that is processed by multiple applications, which may have different protocols, in a computer network environment. More specifically, the present invention relates to methods and systems for passing, or “pipelining”, events between specialized modules in a low-latency manner on a system where a number of hardware processing units is constant. Merely by way of an example, the present invention has been applied to network security applications. But it would be recognized that the invention has a much broader range of applicability.

Telecommunication techniques have been around for numerous years. In the early days, certain people such as the American Indians communicated to each other over long distances using “smoke signals.” Smoke signals were generally used to transfer visual information from one geographical location to be observed at another geographical location. Since smoke signals could only be seen over a limited range of geographical distances, they were soon replaced by a communication technique known as telegraph. Telegraph generally transferred information from one geographical location to another geographical location using electrical signals in the form of “dots” and “dashes” over transmission lines. An example of commonly used electrical signals is Morse code. Telegraph has been, for the most part, replaced by telephone. The telephone was invented by Alexander Graham Bell in the 1800s to transmit and send voice information using electrical analog signals over a telephone line, or more commonly a single twisted pair copper line. Most industrialized countries today rely heavily upon telephone to facilitate communication between businesses and people, in general.

In the 1990s, another significant development in the telecommunication industry occurred. People began communicating to each other by way of computers, which are coupled to the telephone lines or telephone network. These computers or workstations coupled to each other can transmit many types of information from one geographical location to another geographical location. This information can be in the form of voice, video, and data, which have been commonly termed as “multimedia.” Information transmitted over the Internet or Internet “traffic” has increased dramatically in recent years. In fact, the increased traffic has caused congestion, which leads to problems in responsiveness and throughput. This congestion is similar to the congestion of automobiles on a freeway, such as those in Los Angeles Calif. As a result, individual users, businesses, and others have been spending more time waiting for information, and less time on productive activities. For example, a typical user of the Internet may spend a great deal of time attempting to view selected sites, which are commonly referred to as “Websites,” on the Internet. Additionally, information being sent from one site to another through electronic mail, which is termed “e-mail,” may not reach its destination in a timely or adequate manner. Another limitation of conventional networking applications is security.

As the network becomes more complex and important, security violations occur. Users and owners of computer networks combat potential security violations using network security applications. These applications include, among others, fire walling, virus scanning, spam scanning, spy ware filtering, URL filtering, reporting, virtual private network, commonly called “VPN,” rogue protocol controlling, etc. As more and more of these applications are applied to information on the network, the network becomes less efficient and slower. To further combat the limitations introduced by these types of applications, other computing techniques have been introduced.

As merely an example, it is also desirable to have the same computer to perform many functions in a network setting. Such approach has various advantages, such as convenience and lowered costs. For example, it is sometimes desirable for a user to use one computer at the edge of the network to perform various tasks related to network security, such as firewalling, virus scanning, spam scanning, spyware filtering, URL filtering, reporting, VPN, rogue protocol controlling, etc. Using only one computer is less expensive than using more than one computer from hardware perspective. Additionally, it is often easier for a network administrator set up one computer for a given network.

Various techniques have been implement to use one computer to perform various network functions, including those to overcome the limitations described. For example, a technique called proxy chaining is sometimes used. Other conventional techniques includes taking points modules with each of their own threading model and plugging these points modules together. Unfortunately, conventional techniques as described above are often inadequate for many of the network applications. These and other limitations of the conventional techniques have been overcome, at least in part, by the invention that has been fully described below.

Therefore, it is desirable to have an improved method and system for processing information in a network environment in an efficient manner.

### BRIEF SUMMARY OF THE INVENTION

The present invention relates to network systems. In particular, the present invention provides a method and system for reducing latency time of data that is processed by multiple applications, which may have different protocols, in a computer network environment. More specifically, the present invention relates to methods and systems for passing, or “pipelining”, events between specialized modules in a low-latency manner on a system where a number of hardware processing units is constant. Here, the term “pipelining” is intended to mean a collection of functional units that performs a task in several steps wherein each function unit takes input and produces output, but should interpreted by one of ordinary skill in the art and is not intended to be unduly limiting. Merely by way of an example, the present invention has been applied to network security applications. But it would be recognized that the invention has a much broader range of applicability.

The pipelining of data and events in a low-latency matter among modules is a problem in networking, music, video, cryptographic, and graphics software on machines with a limited number of CPUs. According to certain embodiments, the present invention provides an implementation used to route network traffic and events through a series of modules that perform specific tasks. For example, a module performs specific tasks such as filtering, blocking, manipulating, logging, etc.

Events are passed along the virtual pipeline of modules which perform their respective functions. Events are generic objects which can encapsulate data, exceptions, messages, etc. The pipelining is done in a way that events enter the virtual pipeline, are processed by the modules, and exit the virtual pipeline as quickly as possible. The latency overhead with Low Latency Event Pipelining (LLEP) is linear proportional to the number of modules. It is to be appreciated that this technology can be used to integrate much functionality onto one computer while meeting performance requirements.

According to an embodiment, the present invention provides a method for reducing a latency associated with the stream of information passes through the virtual pipeline. The method is performed in a network system, wherein a stream of information passes through a virtual pipeline of a plurality of modules. Each of the plurality of modules is configured to perform one or more functions. The method includes a step for receiving the stream of information from a first network portion at a first time to define an initiation time. The method also includes a step for processing the stream of information into a plurality of events. The plurality of events includes a first event and a second event. The method additionally includes a step for processing the first event in a first format at a first module of the plurality of modules to determine if the first event is passed to a second module, redirected to another process, or changed to the first event in a second format, or not passed. Additionally, the method includes a step for processing the first event in the second format at a second module of the plurality of modules if the first event is transferred to the second module. Moreover, the method includes a step for determining a second time once the first event in the second format has been processed in the second module. The method also includes a step for maintaining a first processor context during at least the processing of the first event in the first format in the first module and the first event in the second format in the second module. And the method includes a step for maintaining a latency time within a determined amount between the first time and the second time.

According to another embodiment, the present invention provides a method for processing one or more streams of information through more than one networking applications. The method includes a step for transferring a stream of information from a first network portion to a second network portion. The method additionally includes a step for receiving the stream of information at a first time. Additionally, the method includes a step for parsing the stream of information from a first format into a second format. The second format is corresponding to a segment of data. The method additionally includes a step for buffering the segment of data in one or more storage devices. In addition, the method includes a step for processing the segment of data using at least a first application process, while the segment of data is maintained in the one or more storage devices. The method includes a step for processing the segment of data using at least a second application process, while the segment of data is maintained in the one or more storage devices. The method also includes a step for processing the segment of data using at least an Nth application process, while the segment of data is maintained in the one or more storage devices, where N is an integer greater than 2. Moreover, the method includes a step for transferring the segment of data at a second time.

According to another embodiment, the present invention provides a virtual pipeline to be used for a system in a communication network. The system processes and transfers one or more information streams through one or more dynamically constructed virtual pipelines. Each of the dynamically constructed virtual pipelines is associated with an information stream. The virtual pipeline includes an entry point. The entry point is configured to receive the information stream from a first portion of the communication network and process the information stream into a plurality of events. The virtual pipeline additionally includes a first relay that is configured to receive and send a first event. The virtual pipeline also includes a first module configured to process the first event in a first format to determine if the first event is to be passed, redirected, or changed to a first event in a second format, or not passed. Additionally, the virtual pipeline includes a second relay that is configured to receive and transfer the first event in the second format if the first event is passed. Also, the virtual pipeline includes a second module configured to process the first event in the second format if the first event is transferred to the second module. Moreover, the virtual pipeline includes an exit point configured to receive and transfer the first event. While in operation, the virtual pipeline maintains a first processor context during the processing of the first event in the first format in the first module and the first event in the second format in the second module.

According to another embodiment, the present invention provides a computer containing a plurality of codes for reducing a latency associated with the stream of information passes through the virtual pipeline. The computer program product to be used in a network system, wherein a stream of information passes through a virtual pipeline of a plurality of modules. The computer program product includes codes for receiving the stream of information from a first network portion at a first time to define an initiation time. The computer program product also includes codes for processing the stream of information into a plurality of events. The plurality of events includes a first event and a second event. Additionally, the computer program product includes codes for processing the first event in a first format at a first module of the plurality of modules to determine if the first event is passed to a second module, redirected to another process, or changed to the first event in a second format, or not passed. Moreover, the computer program product includes codes for processing the first event in the second format at a second module of the plurality of modules if the first event is transferred to the second module. The computer program product additionally includes codes for determining a second time once the first event in the second format has been processed in the second module. In addition, the computer program product includes codes for maintaining a first processor context during at least the processing of the first event in the first format in the first module and the first event in the second format in the second module. Additionally the computer program product includes codes for maintaining a latency time within a determined amount between the first time and the second time.

It is to be appreciated that the present invention provides an improved method for handling network traffic. According to an embodiment, the number of context switches is reduced, causing a reduced latency time. According to certain embodiments, fewer buffer copies are used to reduce hardware load.

Various additional objects, features and advantages of the present invention can be more fully appreciated with reference to the detailed description and accompanying drawings that follow.

### BRIEF DESCRIPTION OF THE DRAWINGS

FIG. 1 is simplified block diagram illustrating a low-latency event pipeline system according to an embodiment of the present invention.

FIG. 2 is a simplified diagram illustrating a network system implemented using a virtual pipeline according to certain embodiments of the present invention.

FIG. 2A is a simplified diagram illustrating a relay according to an embodiment of the present invention

FIG. 3 is a simplified diagram illustrating a full duplex virtual pipeline according to an embodiment of the present invention.

FIG. 4 is a simplified diagram illustrating relay states according to an embodiment of the present invention.

FIG. 5 is a simplified diagram illustrating a system with two virtual pipelines according to an embodiment of the present invention.

FIG. 6 is a simplified diagram illustrating a virtual pipeline used in a wide area network according to an embodiment of the present invention.

FIG. 7A is a simplified diagram illustrating the latency associated with conventional proxy chaining technique.

FIG. 7B is a simplified diagram illustrating the latency and hardware usage according to an embodiment of the present invention.

### DETAILED DESCRIPTION OF THE INVENTION

The present invention relates to network systems. In particular, the present invention provides a method and system for reducing latency time of data that is processed by multiple applications, which may have different protocols, in a computer network environment. More specifically, the present invention relates to methods and systems for passing, or “pipelining”, events between specialized modules in a low-latency manner on a system where a number of hardware processing units is constant. Here, the term “pipelining” is intended to mean a collection of functional units that performs a task in several steps wherein each function unit takes input and produces output, but should interpreted by one of ordinary skill in the art and is not intended to be unduly limiting. Merely by way of an example, the present invention has been applied to network security applications. But it would be recognized that the invention has a much broader range of applicability.

As mentioned above, various conventional techniques for using one computer to perform more than one network applications have their disadvantages. For example, one of the disadvantages of conventional techniques is a high latency, which slows down the network speed. Depending upon applications, the latency associated with proxy chaining sometimes renders many applications unusable. For example, a high latency in a network is often a critical problem for applications involving networking, music, cryptographic, and graphics software on machines with limited number of CPUs. A reason for the high-latency associated with proxy chaining is that latency is super-linearly (e.g., polynomial or quadratic) proportional to the number of proxies. For example, a fifty percent increase in the number of proxies used in proxy chaining can increase the latency by two hundred percent. Similarly, other approaches such as plugging various modules together to process network functions often have high latency that does not meet the latency requirement of various networks.

It is therefore to be appreciated that the present invention presents a new method and system with a lower latency. According to certain embodiments, the present invention provides a system a method to route network traffic and events through a series of modules which perform specific tasks such as filtering, blocking, manipulating, logging, etc.

A. Overview

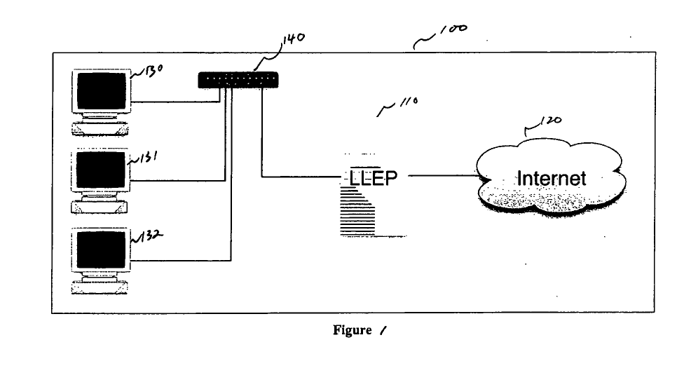

According to certain embodiments, the present invention provides system where streams of information are transferred through a network with a reduced latency. As merely a example, a low-latency event pipeline (LLEP) system according to an embodiment of the present invention is used in a computer network environment. FIG. 1 is simplified block diagram illustrating a low-latency event pipeline system according to an embodiment of the present invention. This diagram is merely an example, which should not unduly limit the scope of the claims. One of ordinary skill in the art would recognize many variations, alternatives, and modifications. A computer network system 100 includes the Internet 120, an LLEP 110, a router 140, and client computers 130, 131, and 132. Streams of information transferred between client computers and the Internet 120 pass through the LLEP 110, which performs various functions, such as firewall, anti-spam, etc. According to various embodiments, the LLEP 110 is transparent (i.e., invisible to clients computers, server, and the Internet). The LLEP 110 is capable of allocating resources and constructing virtual pipelines for transferring and processing of data. For example, the LLEP 110 dynamically construct virtual pipelines according to the data being passed through. As merely an example, the LLEP 110 constructs a virtual pipeline that includes codec modules for processing media files.

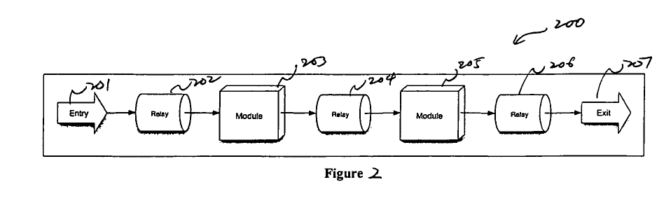

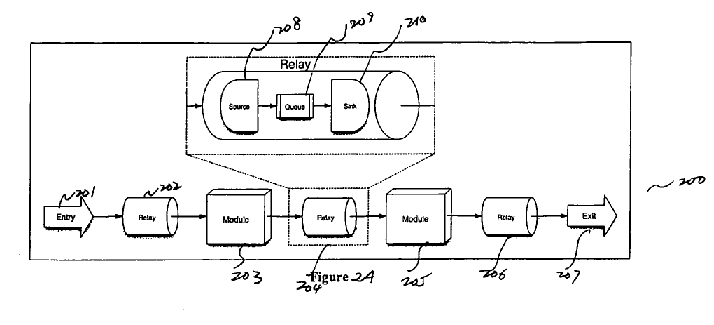

FIG. 2 is a simplified diagram illustrating a network system implemented using a virtual pipeline according to certain embodiments of the present invention. This diagram is merely an example, which should not unduly limit the scope of the claims. One of ordinary skill in the art would recognize many variations, alternatives, and modifications. The virtual pipeline 200 is used to transfer and process events that are derive from information streams.

Events are generic objects which can encapsulate data, exceptions, messages, etc. According to certain embodiments, an event may include network information or media contents. For example, events are chunks of TCP streams, close or reset events for TCP, UDP packets, ICMP packets, etc. In addition, Events can be messages between modules, or advanced representations of the data being sent (i.e. an HTTP request object instead of just a chunk of bytes). According to certain embodiments, events can be dropped, queued, changed, or spontaneously created by modules.

The virtual pipeline 200 includes an entry 201, an relay 202, a module 203, a relay 204, a module 205, a relay 206, and an exit 207. The modules 203 and 205, which are linked together by relays, are configured to perform various tasks such as filtering, blocking, manipulating, logging, etc. A relay is an object that represents connects two points on the pipeline. For example, relay 202 connects the entry 201 and the module 203.

According to an embodiment, a stream of information is encapsulated into an event. When an event occurs, the event often feeds in at the entry 201 of the virtual pipeline 200. According to certain embodiments, the entry 201 is where the virtual pipeline 200 starts handling streams of information. As an example, the entry 201 is a source tied to a file descriptor or a packet hook. When the event feeds into the entry 201, the file descriptor that is tied to the entry 201 wakes a thread that handles the pipelining of the virtual pipeline 200.

After the events feeds at the entry 201, the event is sent to the relay 202. According to certain embodiments, each relay includes three components: a source, a sink, and a queue. FIG. 2A is a simplified diagram illustrating a relay according to an embodiment of the present invention. This diagram is merely an example, which should not unduly limit the scope of the claims. One of ordinary skill in the art would recognize many variations, alternatives, and modifications. The relay 204 is a part of the virtual pipeline 200. As an example, the relay 204 share substantially the same structure as the relay 202 and the relay 206. The relay 204 includes a source 208, a queue 209, and a sink 210. The source 208 is an object that represents a generic source that creates events. The sink 210 represents a generic sink that consumes events. The queue 209 holds all the events already read from the source, but not yet written to the sink. Once the sink 210 becomes writable, the event is sent to the sink 210. If the sink 201 consumes the event, the event is removed from the queue 209.

When the sink 201 consumes the event, the sink 201 notify any interested listeners that an event is in the sink 201. According to certain embodiments, interested listeners can be modules that are configured to process the event. For example, the module 205 is an interested listener for the event at the sink 201. The module 205 may perform various type of tasks on the event. For example, the module 205 takes the event from the sink and process the event. After the event is processed, the module 205 places the event in source of the next relay, which is relay 206. The process of passing events from a relay to a module and then to a next relay continues until the event reaches the a final relay. For example, the relay 207 is the final relay. The relay 206, like relay 204, includes a sink (not shown on FIG. 2A). The sink of relay 206 is tied to a file descriptor. When the event is written to the sink of relay 206, the sink writes the even to the file descriptor. According to certain embodiments, the file descriptor triggers the virtual pipeline 200 to carry the event to the exit 207. Depending upon applications, the exit 207 determines where the event will go next. For example, the exit 207 may send event back to network traffic. According to an embodiment, the entry 201 and the exit 207 are file descriptors or packet receiving and sending hooks. According to certain embodiments, the entry 201 and the exit 207 can be any object which generates or transmits network traffic.

FIGS. 2 and 2A merely illustrates an exemplary embodiment, which should not unduly limit the scope of the claims. One of ordinary skill in the art would recognize many variations, alternatives, and modifications. For example, the virtual pipeline 200 may include more relays and modules.

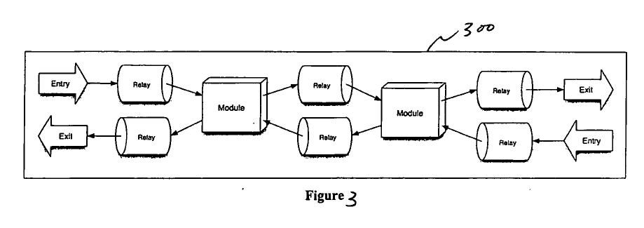

Sometimes, it is desirable to implement the present invention according to network protocols that are full duplex, in which network traffic passes in more than one direction. FIG. 3 is a simplified diagram illustrating a full duplex virtual pipeline according to an embodiment of the present invention. This diagram is merely an example, which should not unduly limit the scope of the claims. One of ordinary skill in the art would recognize many variations, alternatives, and modifications. The virtual pipeline 300 contains relays in two directions. Each network connection receives its own virtual pipeline such as the virtual pipeline 300 and is dependent from one another. For example, each instance of a virtual pipeline, which may be referred to as a session, is different. The modules of a particular virtual pipeline is different form modules from a module of a different virtual pipeline. According to certain embodiments, modules sometimes change over time. According to an embodiment, each virtual pipeline can be dynamically constructed and modified by adding or removing modules.

B. Resources

Low-latency event pipelining (LLEP) according to certain embodiments of the present invention minimizes context switches and buffer copies. As a result, the present invention achieve many benefits, which include latency minimized and throughput maximized. For example, latency is defined as the time it takes for an event to enter a virtual pipeline on one end and exit the other. As an example, throughput is the number of events that can flow through the virtual pipeline at any given time. Often, high throughput can be relatively easily achieved by guaranteeing of some CPU timeslices, as opposed to getting CPU timeslices at correct times.

For each context switch required for an event to fully traverse the pipeline, the processing thread must compete on the CPU run queue and wait. Often, buffer copies and excessive CPU usage increase timeslices thus raising the penalty for all context switches. It is to be appreciated that according to certain embodiments of the present invention, an LLEP delegates events in such a way that generally no context switches are required for an event to traverse the pipeline. In rare cases where one or more context switches is required because the CPU timeslice expires, the penalty is minimized because there is less competition for the CPU usage.

C. Threading Models

According to certain embodiments, the present invention is implemented using an optimized threading model. Compared to conventional threading models, the optimized threading model according to an embodiment of the present invention offers better performance.

Often, conventional threading models fail to meet low latency requirements. For example, it is not possible to meet latency requirements by binding threads to relays or modules. If there is a thread responsible for each module or relay (like in proxy chaining), a context switch will be required at the time the module must run its application specific code. When a CPU is loaded and other sessions are active, repeatedly context switching exacerbates the latency often up into the 100's of milliseconds and seconds.

In contrast to conventional threading models, the present invention provides an optimized threading model. According to certain embodiments, a thread is bound to either a particular virtual pipeline or a particular event. As result, the use of context switches is reduced and sometimes avoided. For example, when a thread is bound to a particular virtual pipeline, the thread is bound to the entire virtual pipeline and handles all the relays of that session. This same thread, which may be called the session thread, will be used execute all codes that are specific to a module's application. It is to be appreciated that when this method of threading is used, there are no required context switches for an event to traverse the entire pipeline. This is because the same thread is doing all the pipelining processing and module processing.

According to an embodiment, each thread is bound to an event, and the number of context switches is also reduced. However, under certain situations, such as when the number of events is high, the creation and destruction of events renders makes the threading process intensive.

Implementation

According to certain embodiments, to implement the thread to handle a virtual pipeline and its module execution, two things are done. First, a application-specific module code is written so that it does not store any state on the stack, or its stack state are automatically saved and restored prior to calling. For example, this is because the module cannot “own” a session thread, and can not hold it indefinitely. Second, a session thread must monitor the state of all source and sinks so that at any given time it can read new events from ready sources to non-full relay queues and send waiting events from relay queues to non-full sinks. For example, the monitoring process is performed in a constant time algorithm to avoid excessive system calls and system resources.

According to an embodiment, modules share memories and states. It is to be appreciated that sharing memories and states having various advantages. For example, events can be passed without copies reducing CPU usage. In addition, redundant processing among modules may be avoided or reduced. In networking, redundant processing happens when multiple modules are parsing the same protocol. Redundant processing can be avoided by passing the already parsed objects to subsequent modules for processing, and appending any addition metadata. According to an embodiment, memories and states sharing significantly reduce processing of sessions with many participating modules.

Process

According to an embodiment, when the session thread feeds an event to a sink that is connected to a module, the sink will consume this event and call into the associated module. The associated module can then read this event from the sink, and pass, queue, hold, drop, or modify this event. In order to pass the event, the associated module places the event in the corresponding source on the other side of the module. The event is then passed on the next tick. When the module is done, it will return the thread, which then handles all other events for that tick. Next, the thread proceeds to the next tick.

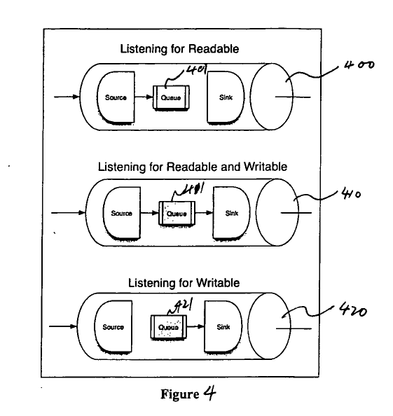

According to certain embodiments, the abovementioned implementation is done with tools such as poll( ) select( ). As an example, user space events and constant are not linear proportional to the listening set. The session thread passes any events that are passable at any given tick. The process may be illustrated by FIG. 4. FIG. 4 is a simplified diagram illustrating relay states according to an embodiment of the present invention. This diagram is merely an example, which should not unduly limit the scope of the claims. One of ordinary skill in the art would recognize many variations, alternatives, and modifications.

As illustrated according to FIG. 4, a relay may be in state 400, state 410, or state 420. At state 410, the queue 401 is empty, and the relay is in a state listening for readable, and the thread adds source to the listen for the readable list. At state 420, the queue 411 is neither empty nor full, the relay is in a state listening for both readable and writeable. When the relay is at state 420, the queue 421 is full, and the relay is in the state of listening for writable only. According to an embodiment, at any given tick, the session thread will service any ready sources and ready sinks, and the thread will go back to sleep until something in the listening set occurs. According to certain embodiments, it is important that the implementation is used to listen on all sources and sinks is of constant time order in the number of sources and sinks, unlike poll or select.

According to an alternative embodiment, implementations use epoll( ) and Kevents of GNU/Linux and FreeBSD respectively, but these only listen to file descriptor based events. This means all sources and sinks must be file descriptor based. This implement may increase the likelihood of the session thread being put at the end of the run queue due to the extra system calls. In addition, while this implementation is feasible, it may have disadvantages such as using excessive file descriptors.

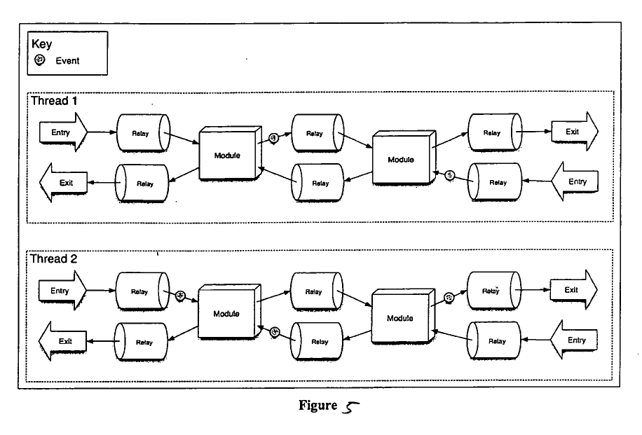

According to certain embodiments, one thread per session allows for easy tuning of priorities, stopping, pausing, and the locking model. Other advantages includes deadlock guarantees because session threads are independent aside from sharing common resources. FIG. 5 is a simplified diagram illustrating a system with two virtual pipelines according to an embodiment of the present invention. This diagram is merely an example, which should not unduly limit the scope of the claims. One of ordinary skill in the art would recognize many variations, alternatives, and modifications. As can be seen on FIG. 5, two virtual pipelines are implement with two threads. According to an embodiment, external threads are allowed to enter into modules and cause spontaneous events. This is required from many applications accessing external resources.

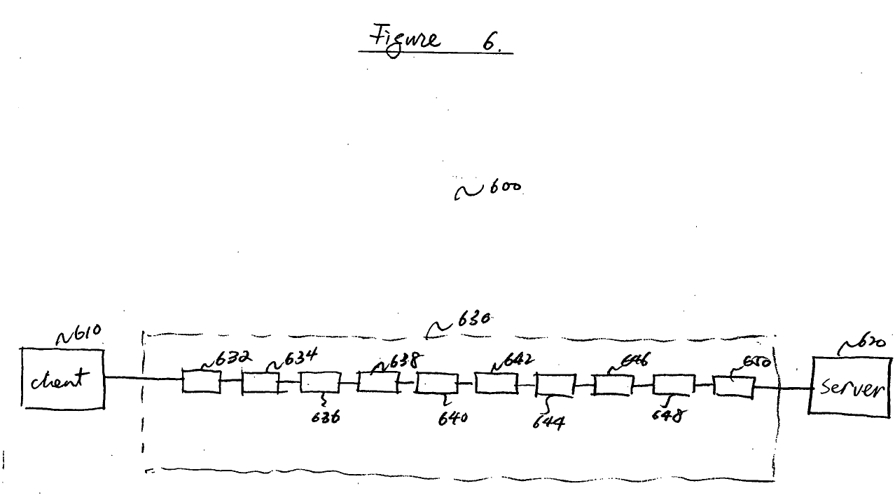

To prove the principle and operation of the present method and system, we provided the following example, which is illustrate according to FIG. 6. FIG. 6 is a simplified diagram illustrating a virtual pipeline used in a wide area network according to an embodiment of the present invention. This example is merely an illustration, which should not unduly limit the scope of the present invention. In this example, the network was a wide area network. We used a computing system having a general purpose processor.

In FIG. 6, a wide area network 600 includes a client 610 and a server 620. For example, the client 610 is a person computer and the server 620 is a web server, which is running, reachable, and responsive to HTTP requests. The client 610 and the server 620 are connected by the virtual pipeline 630. The virtual pipeline 630 includes, as merely an example, includes ten modules: a firewall module 632, a rogue protocol control module 634, a web content control module 636, an anti-spyware module 638, an anti-virus module 640, an anti-virus module 642, an intrusion prevention module 644, and a network address translation modules 646.

According to an embodiment, the communication between the server and the client starts with the client 610 trying to connect to the server 620 to get an HTML web page. The virtual pipeline 630 is constructed to serve the needs of the client 610. For example, the applications that are needed for the client 610 is determined, and modules that are capable of performing these applications are implemented for the virtual pipeline 630. During the process that the client 610 connects to the server 620, an initial connection is established. The client 610 sends a TCP SYN packet towards Server to initiate new HTTP connection. The virtual pipeline 630 intercepts packet and transforms packet into session-request event.

According to an embodiment, the virtual pipeline 630 begins the process of module session-request handling. Each module at the virtual pipeline 630 that receives a session-request event has one of these options: accept, reject, or modify. If a module chooses to accept, the module accept the session without modifying it, and the module emits the unchanged event to the next module in the pipeline. If a module chooses to reject, the session-request event is not delivered to any modules further along in the pipeline. According to an embodiment, the client 610 is notified that the session was rejected via an ICMP packet or TCP RST packet. If a module chooses to modify, a modified session-request event is emitted to the next module in the pipeline. For example the Server IP address is modified.

After the process of module session-request handling, the virtual pipeline 630 begins to process information. First, the firewall module (the first module of the virtual pipeline) 632 receives session-request event. The firewall modules 632 evaluates its rule set against the event. If the result of evaluating the rule set is “pass”, the firewall accepts the session. If the result of evaluating the rule set is “block”, the firewall rejects the session. If firewall accepted the session, the rogue protocol control module 634 (the second module in the virtual pipeline 630) in the pipeline receives the unmodified session-request event.

According to an embodiment, the protocol control module 634 always accepts the session. Merely as an example, each module in turn receives the session-request event. Eventually the event reaches the network address translation (NAT) module 650. If the client is in the translated address space, the NAT module 650 modifies the session by sending a session-request event with modified client IP address and possibly port number.

When the session-request event reaches the end of the pipeline, it is transformed back into a TCP SYN packet. The resulting TCP SYN packet is sent to the server 620. The server responds with a TCP SYN/ACK packet. Next, the SYN/ACK packet is received by the client 610. The client 610 responds with a TCP ACK packet. The ACK packet is then received by the server 620. The three-way TCP handshake is now complete and the session is live.

According to an embodiment, the virtual pipeline 610 is used in HTTP request handling. First, the client 610 sends TCP data packet towards the server 620 containing HTTP request line and request header. Next, the virtual pipeline 630 intercepts packet and transforms packet into data event. Then the module HTTP request handing process starts. Each module that receives the data event has various options: emitting the unchanged data, emitting nothing, or emitting a modified data event to the next module, emit a new data event in the opposite direction, and emitting a shutdown or reset event. Under the first option, the data event is emitted unchanged. If the module choose to emit nothing, the module may wait for the entire request to be able to determine which action to take. If the module choose to emit a modified data event to the next module, modified event might correspond to a parsed interpretation of the request or a redirection of the request to another URI. If the module choose to emit a new data event, the new data event is emitted in the opposite direction and back towards the client 610. If the module choose to emit a shutdown or reset event, the event is emitted towards the server or the client or both. For example, this options has the effect of closing or resetting the session in that direction.

After the request handling process is complete, the firewall module 632 receives the data event and emits the data event unchanged. Next the rogue protocol control module 634 receives the data event. The rogue protocol control module 634 evaluates data to determine the protocol of the session. If the protocol is designated as prohibited, a reset event is emitted in both directions. If the protocol is undetermined or not designated as prohibited, the unchanged data event is emitted.

As an example, assuming that the rogue protocol control module emits the data event, the web content control module 636 receives the data event. The web content control module 636 evaluates HTTP request to determine if the request is prohibited. If so, a new data event is emitted back towards the client 610. This takes the form of a valid HTTP response of letting the user know that the resource requested was prohibited. On the other hand, if the request was not prohibited, the unchanged data event is emitted.

As merely an example, assuming that the TCP data event containing the HTTP request reaches the end of the virtual pipeline 630, it is transformed back into a TCP data packet. The resulting TCP data packet is sent to the server 620, which in turn handles the request.

According to an embodiment, the virtual pipeline 610 is used in HTTP response handling. The virtual pipeline 610 functions in substantially the same way as HTTP request handling. For example, the server 620 sends TCP data packet towards server 620 containing the response line, response header, and response body (if any). The virtual pipeline 630 intercepts packet and transforms packet into data event. Then the module HTTP response handing process starts. Each module that receives the data event has various options: emitting the unchanged data, emitting nothing, or emitting a modified data event to the next module, emit a new data event in the opposite direction, and emitting a shutdown or reset event. Under the first option, the data event is emitted unchanged. If the module choose to emit nothing, the module may wait for the entire request to be able to determine which action to take. If the module choose to emit a modified data event to the next module, modified event might correspond to a parsed interpretation of the request or a redirection of the request to another URI. If the module choose to emit a new data event, the new data event is emitted in the opposite direction and back towards the client 610. If the module choose to emit a shutdown or reset event, the event is emitted towards the server or the client or both. For example, this options has the effect of closing or resetting the session in that direction.

As an example, assuming that each module passes the event unchanged, the response propagates through the virtual pipeline 630 back to the client 610. The exemplary sequence for handling HTTP traffic is complete.

According to an embodiment, the present invention provides a method for reducing a latency associated with the stream of information passes through the virtual pipeline. The method is performed in a network system, wherein a stream of information passes through a virtual pipeline of a plurality of modules. Each of the plurality of modules is configured to perform one or more functions. The method includes a step for receiving the stream of information from a first network portion at a first time to define an initiation time. The method also includes a step for processing the stream of information into a plurality of events. The plurality of events includes a first event and a second event. The method additionally includes a step for processing the first event in a first format at a first module of the plurality of modules to determine if the first event is passed to a second module, redirected to another process, or changed to the first event in a second format, or not passed. Additionally, the method includes a step for processing the first event in the second format at a second module of the plurality of modules if the first event is transferred to the second module. Moreover, the method includes a step for determining a second time once the first event in the second format has been processed in the second module. The method also includes a step for maintaining a first processor context during at least the processing of the first event in the first format in the first module and the first event in the second format in the second module. And the method includes a step for maintaining a latency time within a determined amount between the first time and the second time. For example, the method for reducing a latency associated with the stream of information passes through the virtual pipeline is implemented according to FIGS. 2-5.

According to another embodiment, the present invention provides a method for processing one or more streams of information through more than one networking applications. The method includes a step for transferring a stream of information from a first network portion to a second network portion. The method additionally includes a step for receiving the stream of information at a first time. Additionally, the method includes a step for parsing the stream of information from a first format into a second format. The second format is corresponding to a segment of data. The method additionally includes a step for buffering the segment of data in one or more storage devices. In addition, the method includes a step for processing the segment of data using at least a first application process, while the segment of data is maintained in the one or more storage devices. The method includes a step for processing the segment of data using at least a second application process, while the segment of data is maintained in the one or more storage devices. The method also includes a step for processing the segment of data using at least an Nth application process, while the segment of data is maintained in the one or more storage devices, where N is an integer greater than 2. Moreover, the method includes a step for transferring the segment of data at a second time. For example, the method for processing one or more streams of information through more than one networking applications is implemented according to FIGS. 2-5.

According to another embodiment, the present invention provides a virtual pipeline to be used for a system in a communication network. The system processes and transfers one or more information streams through one or more dynamically constructed virtual pipelines. Each of the dynamically constructed virtual pipelines is associated with an information stream. The virtual pipeline includes an entry point. The entry point is configured to receive the information stream from a first portion of the communication network and process the information stream into a plurality of events. The virtual pipeline additionally includes a first relay that is configured to receive and send a first event. The virtual pipeline also includes a first module configured to process the first event in a first format to determine if the first event is to be passed, redirected, or changed to a first event in a second format, or not passed. Additionally, the virtual pipeline includes a second relay that is configured to receive and transfer the first event in the second format if the first event is passed. Also, the virtual pipeline includes a second module configured to process the first event in the second format if the first event is transferred to the second module. Moreover, the virtual pipeline includes an exit point configured to receive and transfer the first event. While in operation, the virtual pipeline maintains a first processor context during the processing of the first event in the first format in the first module and the first event in the second format in the second module. For example, the virtual pipeline to be used for a system in a communication network is implemented according to FIG. 2-5.

According to another embodiment, the present invention provides a computer program product containing a plurality of codes for reducing a latency associated with the stream of information passes through the virtual pipeline. The computer program product to be used in a network system, wherein a stream of information passes through a virtual pipeline of a plurality of modules. The computer program product includes codes for receiving the stream of information from a first network portion at a first time to define an initiation time. The computer program product also includes codes for processing the stream of information into a plurality of events. The plurality of events includes a first event and a second event. Additionally, the computer program product includes codes for processing the first event in a first format at a first module of the plurality of modules to determine if the first event is passed to a second module, redirected to another process, or changed to the first event in a second format, or not passed. Moreover, the computer program product includes codes for processing the first event in the second format at a second module of the plurality of modules if the first event is transferred to the second module. The computer program product additionally includes codes for determining a second time once the first event in the second format has been processed in the second module. In addition, the computer program product includes codes for maintaining a first processor context during at least the processing of the first event in the first format in the first module and the first event in the second format in the second module. Additionally the computer program product includes codes for maintaining a latency time within a determined amount between the first time and the second time. For example, the computer program product is implemented according to FIGS. 2-5.

Advantages

It is to be appreciated that the present invention provides an improved method for handling network traffic. According to an embodiment, the number of context switches is reduced, causing a reduced latency time. According to certain embodiments, fewer buffer copies are used to reduce hardware load.

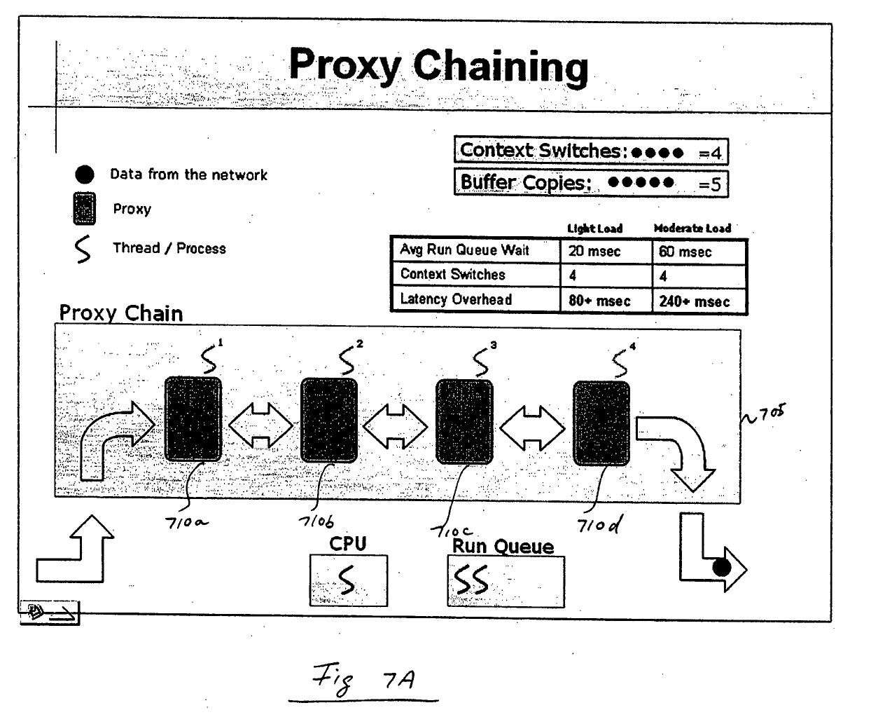

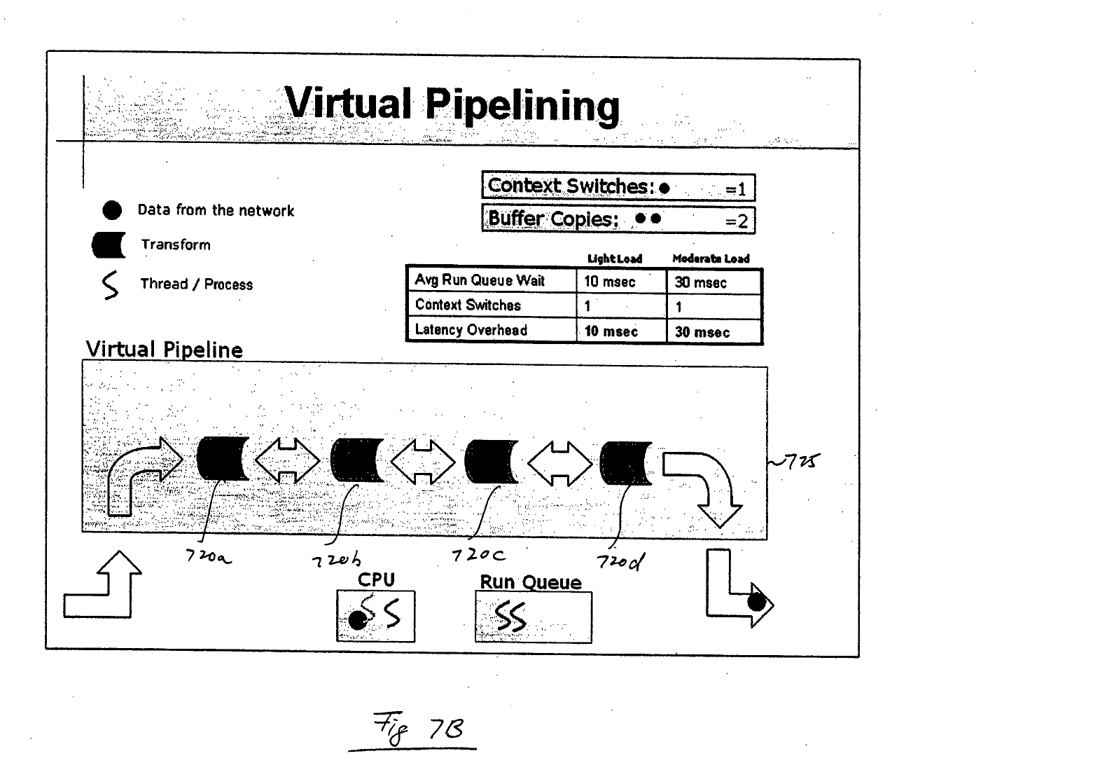

According to certain embodiments, the advantages of the present invention are demonstrated according to FIGS. 7A and 7B. FIG. 7A is a simplified diagram illustrating the latency associated with conventional proxy chaining technique. FIG. 7B is a simplified diagram illustrating the latency and hardware usage according to an embodiment of the present invention. This diagram is merely an example, which should not unduly limit the scope of the claims. One of ordinary skill in the art would recognize many variations, alternatives, and modifications.

As FIG. 7A illustrates, four context switches (710a, 710b, 710c, and 710d) are used to process network traffic. When a network event passes through the proxy 705, each context switch wait for the previous context switch to process. As a result, the latency time is high. For example, the latency time under light load condition is 80 milliseconds, and the latency time under heavy load condition is 240 milliseconds. The latency time polynomially or exponentially proportional to the number of context switches. As a result, as the number of context switches increases, the latency time increases polynomially or exponentially.

According to certain embodiments, the present invention offers much less latency time. As FIG. 7B illustrates, the virtual pipeline 725 includes four modules 720a-720d. Since modules that are capable of performing specific tasks are used, only one context switch is required, and relatively fewer buffer copies are needed. As a result, the latency time is much lower compared that of the proxy chaining technique. For example, the latency time under light load condition is 10 milliseconds, and the latency time under heavy load condition is 30 milliseconds. In addition, the latency time does not increase significantly as the number of modules increases. Rather than being polynomially or exponentially proportional to the number of context switches, the latency time for the present invention is only linearly proportional the number of modules. It is to be appreciated that the advantage of reduced latency time according to the present invention becomes greater as number of modules increase.

It is to be appreciated that, according to certain embodiment of the present invention, latency increases linearly with the number of modules participating in a session, as opposed to super-linearly when the number of context switches increases per module. When a machine is under load this effect is magnified heavily because the run queue length is increased. Systems with bad threading models fall off a performance cliff, while the LLEP will maintain a continuous performance curve.

What is claimed is:

1. In a network system, wherein a stream of information passes through a virtual pipeline of a plurality of modules, each of the plurality of modules configured to perform one or more functions, a method for reducing a latency associated with the stream of information passes through the virtual pipeline comprising:
receiving the stream of information from a first network portion at a first time to define an initiation time;
processing the stream of information into a plurality of events, the plurality of events including a first event and a second event;
processing the first event in a first format at a first module of the plurality of modules to determine if the first event is passed to a second module, redirected to another process, or changed to the first event in a second format, or not passed;
processing the first event in the second format at a second module of the plurality of modules if the first event is transferred to the second module;
determining a second time once the first event in the second format has been processed in the second module;
maintaining a first processor context during at least the processing of the first event in the first format in the first module and the first event in the second format in the second module; and
maintaining a latency time within a determined amount between the first time and the second time.

2. The method of claim 1 wherein:
the plurality of modules comprises N modules;
the latency time is linearly proportional to N.

3. The method of claim 1 wherein:
the plurality of modules comprises N modules;
the latency time is not polynomially or exponentially proportionall to N.

4. The method of claim 1 wherein the virtual pipeline is dynamically constructed in accordance with the stream of information.

5. The method of claim 1 wherein the plurality of modules are protocol independent.

6. The method of claim 1 wherein each of the plurality of modules is characterized by an independent state.

7. The method of claim 1 wherein the virtual pipeline includes at most one context switch.

8. The method of claim 1 wherein the first event is associated with network security.

9. The method of claim 1 wherein the first event comprises IP traffic.

10. The method of claim 1 wherein the virtual pipeline is transparent to a first user.

11. A method for processing one or more streams of information through more than one networking applications, the method comprising:
transferring a stream of information from a first network portion to a second network portion;
receiving the stream of information at a first time;
parsing the stream of information from a first format into a second format, the second format corresponding to a segment of data;
buffering the segment of data in one or more storage devices;
processing the segment of data using at least a first application process, while the segment of data is maintained in the one or more storage devices;
processing the segment of data using at least a second application process, while the segment of data is maintained in the one or more storage devices;
processing the segment of data using at least an Nth application process, while the segment of data is maintained in the one or more storage devices, where N is an integer greater than 2; and
transferring the segment of data at a second time.

12. The method of claim 11 wherein the segment of data is an event.

13. The method of claim 11 wherein the predetermined time is 10 milliseconds.

14. The method of claim 11 wherein the one or more memories is one or more static random access memory device.

15. The method of claim 11 wherein the first process application is associated with security.

16. The method of claim 11 wherein the first process application and the second process application have different protocols.

17. The method of claim 11 wherein N is greater than eight.

18. The method of claim 11 wherein the first application process and the second application process are transparent to a client.

19. The method of claim 11 wherein the first application process and the second application process are transparent to a server.

20. In a system in a communication network, wherein the system processes and transfers one or more information streams through one or more dynamically constructed virtual pipelines, each of the dynamically constructed virtual pipelines being associated with an information stream, a virtual pipeline comprising:
an entry point, the entry point being configured to receive the information stream from a first portion of the communication network and process the information stream into a plurality of events;
a first relay, the first relay being configured to receive and send a first event;
a first module configured to process the first event in a first format to determine if the first event is to be passed, redirected, or changed to a first event in a second format, or not passed;
a second relay, the second relay being configured to receive and transfer the first event in the second format if the first event is passed;
a second module configured to process the first event in the second format if the first event is transferred to the second module;
an exit point configured to receive and transfer the first event;
wherein the virtual pipeline maintains a first processor context during the processing of the first event in the first format in the first module and the first event in the second format in the second module.

21. In a network system, wherein a stream of information passes through a virtual pipeline of a plurality of modules, each of the plurality of modules configured to perform one or more functions, a computer program product containing a plurality of codes for reducing a latency associated with the stream of information passes through the virtual pipeline, the computer program product comprising:
codes for receiving the stream of information from a first network portion at a first time to define an initiation time;
codes for processing the stream of information into a plurality of events, the plurality of events including a first event and a second event;
codes for processing the first event in a first format at a first module of the plurality of modules to determine if the first event is passed to a second module, redirected to another process, or changed to the first event in a second format, or not passed;
codes for processing the first event in the second format at a second module of the plurality of modules if the first event is transferred to the second module;
codes for determining a second time once the first event in the second format has been processed in the second module;
codes for maintaining a first processor context during at least the processing of the first event in the first format in the first module and the first event in the second format in the second module; and
codes for maintaining a latency time within a determined amount between the first time and the second time.
